(19) United States
(12) Patent Application Publication
(10) Pub. No.: US 2014/0059929 A1
(43) Pub. Date: Mar. 6, 2014

(54) SELF CONTAINED PLANTER FOR GROWING SEEDS

(71) Applicants: Mitchell H. Stearn, Highland, NY (US); Jennifer Bright, Middle Village, NY (US)

(72) Inventors: Mitchell H. Stearn, Highland, NY (US); Jennifer Bright, Middle Village, NY (US)

(21) Appl. No.: 14/073,983

(22) Filed: Nov. 7, 2013

Related U.S. Application Data
(63) Continuation-in-part of application No. 13/116,457, filed on May 26, 2011.
(60) Provisional application No. 61/350,682, filed on Jun. 2, 2010.

(51) Int. Cl. A01G 9/10

(52) U.S. Cl. CPC A01G 9/1026
USPC 47/85

(57) ABSTRACT

An improved ornamental planter for gardening and the like is provided. The planter includes soil or some other growing medium, perennial bulbs or seeds for flowers or other plants and an insert positioning the bulbs or seeds an an optimized depth within the container to insure that the plants or flower grow properly out of the container

### RELATED APPLICATIONS

This application is a continuation-in-part of U.S. application Ser. No. 13/116,457 filed on May 26, 2011, now which in turn claims the benefit of U.S. Provisional Patent Application No. 61/350,682, filed Jun. 2, 2010, all incorporated herein by reference in their entirety.

### BACKGROUND OF THE INVENTION

A. Field of Invention

This invention generally relates to the field of horticulture and gardening. In particular, the present invention is directed to a preformed planter for growing seeds.

B. Description of the Prior Art

Flowers and other plants are very popular for many indoor and outdoor applications, including gardens, landscaping and other ornamental biotic arrangements. Such plants can be grown either from bulbs or from seeds. The proper cultivation of plants requires one's attention to a number of factors. These include root depth and positioning, protection from insects and other animals, nutrition and hydration.

Accordingly, it would be desirable to provide a system which can be of assistance in making sure seeds are planted at the proper depth and with the proper spacing, as well as protecting the seeds from animals and providing seeds and roots with proper nutrition and hydration.

### SUMMARY OF THE INVENTION

An ornamental planter for gardening and the like is provided. The planter has a desired, preferably artistically pleasing, shape and size, and includes soil or some other growing medium, one or more plant sources for perennial flowers or other plants, the plant sources including respective bulbs and/or seeds and a positioning insert. In one embodiment, and individual containers or planting pots made from peat moss or some other growing medium such as straw or coconut fiber used for the bulbs. In another embodiment, the insert is formed with holes with a holder for holding one or more seeds. The insert is supported by the sidewall of the container or by a separate support arranged to maintain the insert at a predetermined depth within the container. This depth is selected to ensure that the flowers or other plants from the bulbs or seeds develop and grow out of the container properly.

The planter includes a large opening along the top surface thereof through which the planted bulbs or flowers will grow. This opening is covered with a seal comprised of removable plastic or other material. Also provided is at least one hole or opening formed along the bottom of the planter for ensuring proper drainage.

Optionally, fertilizer in the form of spikes, and powder can be added to the soil in the planter in order to provide nutrients for aiding in the growth of plants. The fertilizer may be placed in the soil or in the planter after the plants have bloomed in order to insure naturalization and repeated flowering in subsequent years. It is noted that the planters can be used for many types of perennial flowers or other plants can be used, depending of course on the time of year, geographic location and visual presentation that is desired. The perennial bulbs or seeds (of one or more varieties or types) may be preconfigured as desired within the soil to allow for different visual effects and blooming schedules.

In one embodiment of the invention, initially, the planter includes one or more bulbs from which the desired plants or flowers will grow. In another embodiment, the flowers or other desired plants grow from seeds are that initially introduced into the planter. In other words, the planter is shipped and sold at retail level with the desired growing medium and, optionally, other nutrients already provided in the planter together with one or more bulbs, several seeds, or, possibly a combination of bulbs and seeds. The number of bulbs and seeds is dependent on the size of the planter, and the expected size of the desired flowers or plants.

In use, the planter of the invention is unwrapped (for exposing the growing medium, with perennial plantings in place, to sun and water) after purchase, with the seal that covers the top surface opening removed, and then placed at a desirable outdoor (or even indoor) location. Water is then regularly dispensed, either through natural rainfall or manual watering depending upon placement (outdoor or indoor) of the planter. No other steps are required.

Thus, the inventive system is advantageous since it does not require the purchase of separate components, soil handling, measuring or bulb/seed planting in order for the system to be fully set up.

Importantly, the positioning insert, is a critical part of the inventive system; its purpose is to prevent shifting of the planting pots or seeds (especially during commercial shipping) located within the soil housed within the planter.

The inventive planter can be used to decorate a garden, home, commercial space, or even a fire escape or rooftop within an urban landscape. Annual plants may be added to the planter after perennial planting cycle has been completed as part of an overall landscaping or planter type of arrangement.

Accordingly, an object of the invention is to provide a pre-packaged potted flower arrangement.

Another object of the invention is to provide an artistically shaped planter which only requires watering for purposes of setting up and maintaining the plants within the planter.

Another object of the invention is to provide repeated years of flowering due to the naturalization of the perennial plantings when the planter is placed in accordance with the USDA Hardliness Zone Map out-of-doors, if placed outdoors, repeated years of flowering can be achieved by moving the planter indoors to a cool, dry location after the growth cycle has finished, adding a fertilizer, and then returning the planter outside to a desired growing location and adding water, thus recommencing growth and utility for the year to come.

Still other objects will be apparent from this description and the attached drawing..

### BRIEF DESCRIPTION OF THE DRAWINGS

For a fuller understanding, reference is made to the following drawing:

FIG. 1 is a perspective cut-away view of a shaped planter constructed in accordance with this invention;

FIG. 2 shows a perspective cut away view of another embodiment of the invention;

FIG. 3 shows a plan view of an alternate embodiment of an insert for the invention; and

FIG. 4 shows a perspective view of the insert of FIG. 3.

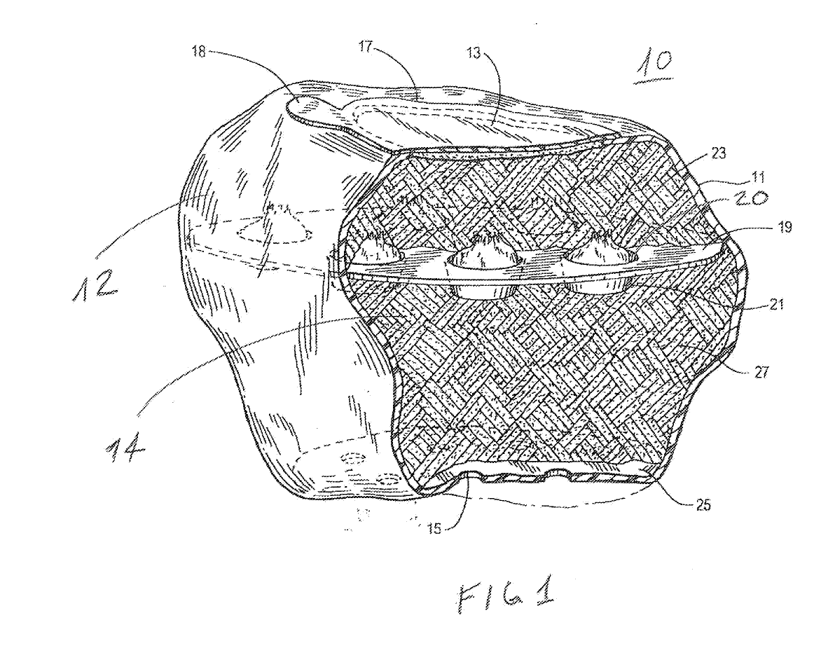

### DETAILED DESCRIPTION OF A PREFERRED EMBODIMENT

Referring to the drawings, a planter 10 constructed in accordance with this invention includes a container housing 11 that can have a generally geometric shape (such as square, cylindrical, etc) or it can have a free form esthetic shape, such as a rock-like or other representational, like an animal or other identifiable object. Alternatively, the planter can hanve an abstract shape. The housing 11 can be made from plastic, fiberglass, an epoxy resin material, an enamel or other material. Container 11 includes, a continuous sidewall 12, an opening 13 formed along the top and a bottom 16 forming a cavity 14. The bottom 16 is provided with a plurality of drainage holes 15. Opening 13 is provided with a removable plastic seal 17 having a pull-tab 18.

Container 11 is filled with a soil or other growing medium 27, such as vermiculite, pearlite and peat moss, or mixtures thereof. Seated approximately half-way down within the interior of container 11 is an insert 19. Insert 19 is preferably flat and sits substantially horizontally within container ii. At least at one point, the insert 19 can abut the sidewall 12 of container 11 along at least a portion thereof. Preferably, the insert 19 is secured to the sidewall 12 of the container 11 either by an adhesive (not shown) or by sizing the insert 19 so that it forms an interference fit with the container sidewall 12. Insert 19 is preferably flat and is made of cardboard, plastic or other similar, preferably biodegradable material. In one embodiment, the insert 10 is formed with holes or openings 20 in which planting pots 21 are nested, Planting pots 21 are made from a growing medium such as peat moss, straw or coconut fibers (peat moss is preferred). Insert 19 is positioned within the container 11 so as to ensure that pots 21 are maintained in position within the center of container 11 and well below the surface of growing medium 27. Each planting pot 21 includes one or more plant bulbs 23 such as perennial bulbs. The optimal distance of the insert 19 from the top of the container varies based on the type of bulbs being disposed in pots 21 and is selected to insure that the bulbs grow into healthy plants that extend through the opening 13 of the container, and that the roots of the plants can extend downwardly from the insert 19 downwardly into the lower portion of the container and toward the bottom 16 of the container. Typically, the placement of seeds in the soil can vary from a depth of ⅛″ to 1″ below the surface and the placement of Bulbs can vary from 1″ to 4″ deep.

As stated before, fertilizer spikes or fertilizer powder may be added inside container 11 and within the soil or other growing medium 27; doing so facilitates re-blooming of the bulbs or plants.

Prior to filling the container with growing medium 27, a water-permeable paper filter 25 (such as a sheet of a paper towel) is placed over the drainage holes 15 to line the bottom of artificial rock container 11 and keep growing medium 27 in place.

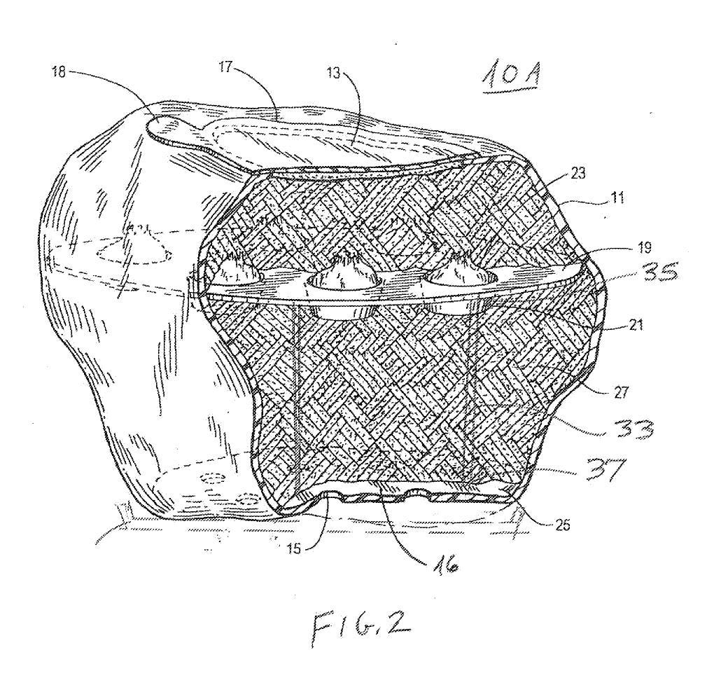

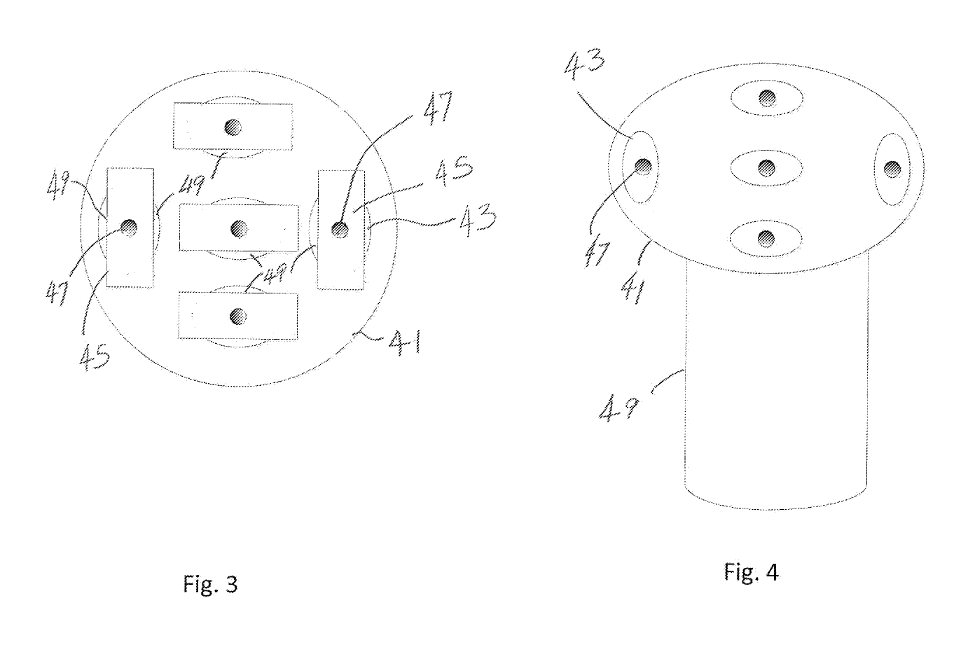

As mentioned above, insert 19 is positioned within the container 11 and maintained in place preferably by an adhesive or an interference fit. In an alternate embodiment shown in FIG. 2, instead or in addition, a support 33 is provided. The support 33 has a generally cylindrical shape having an upper end 35 and a lower end 37 resting on the bottom 16. The support 33 can be made of cardboard or other, preferably biodegradable material. It needs to be just strong enough to hold insert 19 in position, as shown. Preferably, the inside volume of support 33 is filled with the same medium as the rest of the container. Alternatively, the support 33 may be empty. In yet another embodiment, the support 33 can be made solid (for example from a Styrofoam or other light material).

In an alternate embodiment shown in FIGS. 4 and 5, the planter is used for flowers and other plants that grow from seeds. For this purpose, an insert 41 is provided. This insert 41 is sized and shaped so that it fits in container 11 at a predetermined depth. The insert 41 may have a circular shape or any other shape suitable for the container 11. If the container is shaped as a rock,. insert 41 may have a somewhat irregular shape.

Insert 41 is made with a plurality of holes 43. In the Figures, holes 43 are shown as having an elliptic shape, however, they can have any other shapes as well.. The holes 43 are partially covered by tapes 45, each tape 45 holding one or more seeds 47. (In FIG. 4, tapes 45 have been omitted for the sake of clarity). The tapes 45 are preferably adhesive at least on their top surface so they can hold the seeds 47 and can be made of a biodegradable material as well.

Preferably, the tapes 45 have a width that is smaller than the corresponding dimension of the respective hole 43 so that as the tapes 45 are attached to the insert 41, they only partially cover the respective holes 43, leaving gaps 49 therebetween. These gaps insure that any growing medium and/or water introduced through the top opening 13 of container 11 goes through the insert 41 and into the bottom part of the container 11. Alternatively, the insert 41 and/or tapes 45 are made of a pervious material that allows water to flow through to the bottom of the container 11. In another embodiment, additional holes (not shown0 are made in the insert to allow growing medium and/or water to flow to the bottom of the container.

Insert 41 is again positioned at a depth below opening 13 selected to insure that the seeds 47 will germinate properly and develop into healthy and beautiful flowers or other plants. Some typical depth for various types of seeds, can be as follows:,

small seeds such as poppy, pepper and lettuce seeds—⅛″ deep;

medium seeds such as tomato, parsley and daisy—½″ deep;

larger seeds such as sunflower, marigold and zinnia—1″ deep.

Similarly, the number of holes and number of seeds 47 provided at each opening depends on the seeds, the number of flowers desired, the size of the plants and flowers, etc. Typically, there the holes may be 1-1.5 in and may have anywhere from 1-6 seeds, and there may be 1-6 or more holes 43 in the insert 41. Some specific examples are provided below:

Lettuce, marigold, poppy—6 seeds/hole

Sunflower, tomato—2-3 seeds/hole

Zinnia—4 seeds/hole

The insert 41 can be attached to the sidewalls of container by an adhesive or by frictional engagement. Alternatively, a support 49 is provided to position and hold the insert 41 at a desired depth as discussed above in conjunction with FIG. 2.

Although the preformed container of the invention may have the configuration of a rock, other configurations are possible without departing from the scope of the invention.

Further, the container may be produced commercially in different colors in order to coordinate with its intended geographical and/or environmental use.

The scope of the invention will now be set forth in the following claims.

1. A planter comprising:
a container having an open top, a bottom and a sidewall to define a cavity;
a growing medium disposed in said cavity;
an insert disposed at a predetermined depth from said open top and imbedded in said growing medium; and
at least one plant source supported by said insert, said plant source being adapted to grow into a flower or plant in said growing medium;
wherein said predetermined depth is selected to insure that the plant source is suitable positioned in said container to promote the growth and development of said flower or plant.

2. The planter of claim 1, further including a removable cover for selectively closing said open top.

3. The planter of claim 1 wherein said plant source is a bulb.

4. The planter of claim I wherein said plant source is a seed.

5. The planter of claim 1 wherein said insert is formed with at least one hole, and a holder holding said plant source.

6. The planter of claim 5 wherein said plant source is a bulb and said holder is a pot holding said bulb, said pot being sized and shaped to fit into said hole without falling through.

7. The planter of claim 5 wherein said plant source is a seed and said holder is a tape attached to said insert, said tape holding said seed within said hole.

8. The planter of claim 7 wherein said tape covers said hole only partially to allow said medium or water to pass through to the bottom of the container.

9. The planter of claim 1 wherein said insert is permeable to water.

10. The planter of claim 1, wherein said growing medium is selected from soil, vermiculite, pearlite, peat moss and mixtures thereof.

11. The planter of claim 1, wherein said insert is positioned substantially halfway between said top and said bottom of said container.

12. The planter of claim 1, said insert is fixed in position within said growing medium by abutting against at least a portion of said side wall.

13. The planter of claim 1, wherein said insert is planar in configuration.

14. The planter of claim 13, wherein said insert is fixed in position within said growing medium in a substantially horizontal orientation.

15. The planter of claim 6, wherein said pot is made from a growing medium that is selected from the group consisting of peat moss, straw and coconut fibers.

16. The cover of claim 1, wherein said growing medium has fertilizer added thereto.

17. The cover of claim 1, further including a water permeable filter element disposed along said bottom for preventing said growing medium from escaping said container through said one or more holes.

18. A planter for growing plants comprising:
a container with a top with an opening, a bottom, and at least one side wall;
a growing media filling said container; and
an insert attached to said side wall at a predetermined depth below said opening and at a height above, said insert being embedded within said growing medium, said insert being mount a plant source within said growing medium, said predetermined depth being selected to ensure that plant source within said growing medium grows into a plant extending through said opening with a root extending below said insert towards said bottom.

19. The planter of claim 18, further comprising a support extending from said bottom upwardly to said insert to position said insert within said container.

20. The planter of claim 18 wherein said plant source is one of a seed and a bulb.
